(19) United States
(12) Patent Application Publication
(10) Pub. No.: US 2006/0280897 A1
(43) Pub. Date: Dec. 14, 2006

(54) Optical recording medium and method of producing same

(75) Inventor: Osamu Koyama, Hachioji-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/441,027

(22) Filed: May 26, 2006

(30) Foreign Application Priority Data
Jun. 13, 2005 (JP) 2005-172326

(51) Int. Cl. B32B 3/02

(52) U.S. Cl. 428/64.4

(57) ABSTRACT

There is provided an optical recording medium of a type in which a light beam is incident from a protective layer side which strikes a balance between a high track density and excellent mass productivity and which comprises a support substrate; a protective layer with a thickness smaller than that of the support substrate provided on a light beam incidence side; and a recording layer formed between the support substrate and the protective layer, wherein the recording layer comprises a concave portion as a gap between recording tracks and a convex portion as a recording track having a thickness greater than that of the concave portion and formed so as to convex toward the protective layer.

### BACKGROUND OF THE INVENTION

1. Field of the Invention

The present invention relates to an optical recording medium. More specifically, the present invention relates to a multilayer optical recording medium in which a light beam is incident from a protective layer side.

2. Related Background Art

In recent years, optical recording media have been applied as recording media for recording various informations in a computer field, an audiovisual field, and other fields. Furthermore, there is a need for a small-size, large-capacity, optical recording medium as a mobile computer has become widespread and an expanded variety of information have become available.

Hitherto known examples of an optical recording medium for recording or reproducing those informations by using light include an optical recording medium having a single plate structure and an optical recording medium having a laminated structure. The former optical recording medium has a fine embossed pattern (or uneven pattern) such as a pit or a guiding groove for obtaining a tracking servo signal or the like formed on a substrate. A recording layer and, as required, a reflecting layer are formed on the pattern. Furthermore, an organic protective layer is formed on such layers.

The latter optical recording medium is constituted by laminating two substrates with the recording layers or reflecting layers thereof being opposite to each other.

In recent years, to cope with a demand for a further increase in recording density, there has been proposed an optical recording medium obtained by forming a plurality of recording layers on one surface of a substrate. The recording medium has a plurality of recording layers on one substrate surface while a recording medium having a single plate structure or a laminated structure has only one recording layer on one substrate surface. A recording layer is formed on a support substrate having a signal pattern formed thereon. Furthermore, another recording layer is formed on the recording layer via a fine embossed pattern formed layer on which a signal pattern is formed. A signal pattern formed layer and a recording layer are additionally repeatedly formed as needed, and an organic protective layer is formed on the last recording layer. A light incidence plane for recording/reproducing and erasing information may be on the support substrate side, or may be on the organic protective layer side on the last recording layer. However, when the light incidence plane is on the organic protective layer side, the thickness of a light transmissive substrate can be easily reduced. Therefore, the type in which a light is incident from the organic protective layer side is advantageous for an increase in recording density because the numerical aperture (NA) of an objective lens of a pickup can be increased.

First prior art of a multilayer recording medium will be described with reference to FIG. 7. The art is well known as a structure of a digital versatile disc (DVD). On a support substrate 107 for supporting a recording layer made of polycarbonate and having a thickness of 0.6 mm, there is formed a fine embossed pattern such as a guiding groove for obtaining a tracking servo signal or the like. On the fine embossed pattern of the support substrate 107, a first recording layer 104 is applied. When the first recording layer 104 is formed of an organic material, an optical recording medium 101 becomes a write-once read-many type optical recording medium. The write-once read-many type optical recording media have been generally widespread because they can be produced at low cost.

A general process for applying an organic material will be described with reference to FIG. 8. The support substrate 107 is set in a spin coater rotating portion 23. An organic material 24 is dropped from an organic material supplying nozzle 25 onto the support substrate 107. After that, the spin coater rotating portion 23 is rotated at a predetermined number of revolutions so that the organic material 24 is applied to have a predetermined thickness.

Description will be made with reference to FIG. 7 again. In an optical recording medium produced according to such production method, because the organic material is formed in the groove 171 to have a thickness larger than that at a land 172 between two adjacent guiding grooves on the support substrate 107, it is convenient that the organic material positioned in each groove (guiding groove) 171 is used as a recording track. This is because the occurrence of a desired physical change of a recording layer upon recording requires the recording layer to have a sufficient thickness. In actuality, in a write-once read-many type DVD, information is recorded to or reproduced from the first recording layer 104 formed on the groove 171 by using a light beam B. A translucent film (not shown) may be formed on the first recording layer 104 as needed.

As a method of producing an optical recording medium having a multilayer structure, there is a method to be described below. First, a UV curable resin is applied on the first recording layer 104. Next, a transparent stamper (not shown) is overlaid on the UV curable resin. Next, the UV curable resin is irradiated with ultraviolet light through the transparent stamper to be cured. Thus, a fine embossed pattern such as a guiding groove formed on the transparent stamper is transferred onto the UV curable resin, whereby a signal pattern formed layer 173 is formed. After that, the transparent stamper is peeled off from the signal pattern formed layer 173.

The method of forming the signal pattern formed layer 173 utilizes a conventional photopolymer process (hereinafter, referred to as “2P process”). In the conventional 2P method, a UV curable resin and a transparent support substrate are overlaid on a metallic stamper and ultraviolet light is irradiated from the transparent support substrate side to cure the UV curable resin. On the other hand, in the optical recording medium having a multilayer structure, because a reflecting layer or a recording layer is formed on the support substrate 107, even when ultraviolet light is irradiated from the support substrate 107 side, the energy of the ultraviolet light attenuates, with the result that the UV curable resin cannot be sufficiently cured. Therefore, a method has been used in which a transparent stamper is used and ultraviolet light is irradiated from the transparent stamper side.

After that, the process described with reference to FIG. 8 is repeated to apply an organic material onto the signal pattern formed layer 173, whereby a second recording layer 106 is formed. Also at this time, as is the case with the first recording layer 104, each groove on the signal pattern formed layer 173 is filled with the organic material such that the thickness of the organic material is larger there than at a land between two adjacent grooves. A reflecting layer 112 may be provided on the second recording layer 106. Thereby, the quantity of reflected light from the second recording layer 106 positioned further distant from a light incidence plane can be increased. Furthermore, an adhesive 113 is applied to the layer 106 in the same manner as shown in FIG. 8, and a protective layer 102 is formed on the second recording layer 106 through the adhesive 113. For example, a UV curable resin can be used for the adhesive 113.

Another constitution of a multilayer recording medium has been known. FIG. 9 is a cross-sectional view showing second prior art of a multilayer recording medium. In the second prior art a light beam is incident from a protective layer 202 side while in the first prior art a light beam is incident from the support substrate 107 side. The reason why such constitution is adopted is that incidence of a light beam from the protective layer 202 side makes it easy to reduce the thickness of a light transmissive substrate, so that the numerical aperture (NA) of an objective lens of a pickup can be increased, which is advantageous for increase in recording density. The thickness of the protective layer 202 needs to be reduced in accordance with the NA of the objective lens used, and for NA=0.85, the thickness needs to be at least 0.3 mm or less in order to alleviate an influence of a comatic aberration caused by tilting of an optical recording medium. In an example of the second prior art, an organic protective layer having a thickness of 0.05 mm is provided on a support substrate 207 having a thickness of 1.1 mm so as to cover the two recording layers 204, 206.

Therefore, in general, the order in which the recording layers are formed is opposite to the order of the optical recording medium of the first prior art (the direction indicated by an outline arrow in FIG. 9). First, a fine embossed pattern such as a guiding groove for obtaining a tracking servo signal or the like is formed on the support substrate 207, and a reflecting layer 212 is formed by sputtering or the like. A second recording layer 206 is applied on the fine embossed pattern. The second recording layer 206 is formed of, for example, an organic material, and, in such case, the recording medium 201 becomes a write-once read-many type optical recording medium. The spin coating is used in a step for applying the organic material as described with reference to FIG. 8. Each groove (guiding groove) 271 on the support substrate 207 is filled with the organic material such that the thickness of the organic material is larger there than at a land 272 between two adjacent grooves 271.

Next, thee first recording layer 204 is formed on the second recording layer 206. In this step, the method involving use of a transparent stamper as described with reference to FIG. 7 is used. That is, a UV curable resin is applied, and the transparent stamper is pressed against the resin. Ultraviolet light is irradiated from the transparent stamper side, whereby a fine embossed pattern such as a guiding groove formed on the transparent stamper is transferred onto the resin layer. Thus, a signal pattern formed layer 273 is formed. After that, the transparent stamper is peeled off from the signal pattern formed layer 273. Subsequently, in order to form the first recording layer 204, the step described with reference to FIG. 8 is repeated so that an organic material is applied onto the signal pattern formed layer 273. Also at this time, as is the case with the second recording layer 206, each groove on the signal pattern formed layer 273 is filled with the organic material such that the thickness of the organic material is larger there than at a land between two adjacent grooves. In addition, a translucent film (not shown) may be formed between the first recording layer 204 and the signal pattern forming layer 273 as needed. Furthermore, an adhesive 213 is applied thereon, and finally a protective layer 202 is stacked on and adhered thereto. For example, a UV curable resin can be used for the adhesive 213.

FIGS. 10A and 10B show simulation results of estimation of recording power margin for the optical recording media of the first and second prior arts. FIG. 10A shows an example of the first prior art, and is a temperature distribution on a recording track when the recording track is a convex (or protrusion) with respect to the light beam B. FIG. 10B shows an example of the second prior art, and is a temperature distribution on a recording track when the recording track is a concave (or recess) with respect to the light beam B. In each figure, the axis of abscissa indicates a distance in a direction perpendicular to a track (i.e., radial direction), and the axis of ordinate indicates a temperature. The simulation was performed with a recording wavelength of 405 nm, an NA of an objective lens of 0.85, and a track pitch of 0.32 μm. The specifications, which are a representative of the second prior art, are substantially identical to those of a DVD (recording wavelength: 660 nm; NA of objective lens: 0.6; track pitch: 0.74 pm) in terms of a wavelength, an NA, and a track pitch. Therefore, only the simulation results suffice for the estimation of the tendencies of the state of the temperature distribution on the recording track and the recording power margin.

In the example of the first prior art, since the light beam B is incident on a portion which is a convex with respect to the light beam, as shown in FIG. 10A, the range in which the temperature increases greatly is limited to a convex portion 71 of the recording track. Since diffusion of heat to a concave portion 72 is suppressed, the temperature rise in an adjacent track is slight. On the other hand, in the example of the second prior art, when an information is to be recorded to or reproduced from a relatively thick organic material layer in a groove, the light beam B needs to be incident on a portion 73 which is a concave with respect to the light beam. However, in this case, as shown in FIG. 10B, side peaks of the temperature distribution appear at portions 74 which are each a convex with respect to the light beam, so that heat is apt to diffuse into adjacent recording tracks. Therefore, the possibility of crosswrite of the adjacent tracks upon recording increases, so that the recording power margin becomes narrow.

The summary of the foregoing is as described below. In an optical recording medium, when the numerical aperture (NA) of an objective lens of a pickup is to be increased to thereby increase the recording density, the mode in which a light beam is incident from a protective layer side is desirable because the thickness of a light transmissive substrate can be easily reduced. That is, the second prior art is more advantageous than the first prior art. However, when a recording track is set in a portion where an organic material layer is distributed relatively thickly, in a recording medium having a recording layer formed by applying an organic material by spin coating or the like, such portion will have a shape convex in a direction opposite to the direction toward the protective layer, that is, will be a portion which is a concave with respect to the light beam. This is attributable to the stacking order in which stacking is performed on a support substrate. As a result, the recording power margin becomes narrow, thereby making it difficult to increase the track density.

A possible measure to avoid this is to make a light beam incident on a portion which is a convex with respect to the light beam to perform recording/reproduction. However, because this means that a portion where an organic material layer is distributed relatively thinly is used as a recording track, the thickness of a recording layer needs to be increased significantly, which is disadvantageous in terms of production efficiency and production cost

### SUMMARY OF THE INVENTION

It is, therefore, an object of the present invention to provide an optical recording medium of a structure in which a light beam is incident from a protective layer side and a recording layer is formed by application of an organic material using spin coating or the like that strikes a balance between a high track density and excellent mass productivity.

According to one aspect of the present invention, there is provided an optical recording medium, comprising:

a support substrate;

a protective layer with a thickness smaller than that of the support substrate provided on a light beam incidence side; and

a recording layer formed between the support substrate and the protective layer,

wherein the recording layer comprises a concave portion as a gap between recording tracks and a convex portion as a recording track having a thickness greater than that of the concave (or recessed) portion and formed so as to convex (or protrude) toward the protective layer.

According to another aspect of the present invention, there is provided a method of producing an optical recording medium, comprising the steps of:

forming an embossed pattern on a sheet-shaped base member;

forming a recording layer on the embossed pattern of the sheet-shaped base member; and

bonding the sheet-shaped base member and a support substrate such that a surface of the sheet-shaped base member having the recording layer formed thereon and a support surface of the support substrate face each other.

### BRIEF DESCRIPTION OF THE DRAWINGS

FIG. 1 is a cross-sectional view showing a layer constitution of an optical recording medium according to an embodiment of the present invention;

FIG. 2 is a view schematically showing the production steps of a method of producing the optical recording medium shown in FIG. 1;

FIG. 3 is a schematic view showing production steps of a sheet-shaped base member;

FIG. 4 is a schematic view showing a method of applying a recording layer by spin coating;

FIG. 5 is a schematic view showing a step of stacking sheets;

FIG. 6 is a schematic view showing a shape forming step of an optical recording medium;

FIG. 7 is a cross-sectional view showing first prior art of a multilayer recording medium;

FIG. 8 is an explanatory view showing a general step of applying an organic material of the prior art;

FIG. 9 is a cross-sectional view showing second prior art of a multilayer recording medium; and

FIGS. 10A and 10B are graphical representations each showing simulation results of estimation of a recording power margin.

### DESCRIPTION OF THE PREFERRED EMBODIMENTS

Hereinafter, preferred embodiments of the present invention will be described in detail with reference to the drawings.

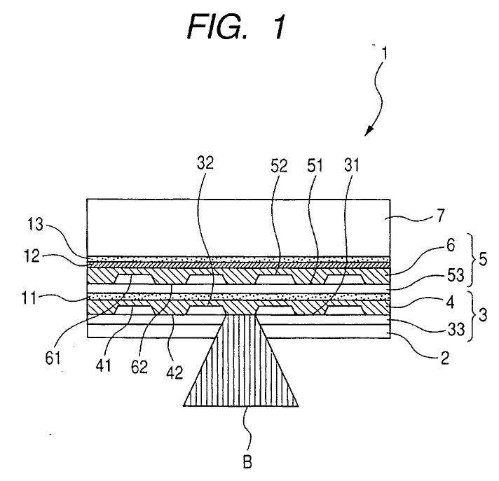

FIG. 1 is a cross-sectional view showing a layer constitution of an optical recording medium according to an embodiment of the present invention.

Although the optical recording medium of the present invention is also applicable to a recording medium having one recording layer or three or more recording layers and such recording medium can have a similar constitution, description will be made by taking a two-layer constitution as an example.

An optical recording medium 1 includes a support substrate 7, and a protective layer 2 which has a thickness smaller than that of the support substrate 7 and is provided on a side on which a light beam B is incident. A first sheet 3 and a second sheet 5 are formed between the support substrate 7 and the protective layer 2 in a direction from the protective layer 2 to the support substrate 7. The first sheet 3 has a first sheet-shaped base member 33 and a first recording layer 4 formed on a surface of the base member.

The second sheet 5 has a second sheet-shaped base member 53 and a second recording layer 6 formed on a surface of the base member. As described above, the type in which the light beam B is incident from the protective layer 2 side is advantageous for an increase in recording density, because the thickness of a light transmissive substrate can be easily reduced, and therefore because the numerical aperture (NA) of an objective lens of a pickup can be increased. The thickness of the protective layer 2 needs to be reduced in accordance with the numerical aperture NA of the objective lens used. In the case of NA9=0.85, in order to alleviate an influence of a comatic aberration caused by the tilting of an optical disk, the thickness needs to be more than 0 mm and to be 0.3 mm or less. In this embodiment, the thickness of the protective layer 2 is 0.05 mm, and the thickness of the support substrate 7 is 1.1 mm.

The first sheet 3 is provided on the protective layer 2. On the first sheet-shaped base member 33, there is formed a fine embossed pattern composed of grooves (guiding grooves) 31 for obtaining a tracking servo signal or the like and lands 32 between two adjacent grooves 31. The first recording layer 4 is composed of an organic material and formed on the surface of the first sheet-shaped base member 33 so as to fill the grooves 31 of the first sheet-shaped base member 33 and to spread over the entire surface of the base member. Each groove 31 of the first sheet-shaped base member 33 is filled with the organic material such that the thickness of the organic material is greater there than that of the land 32. As a result, in the first recording layer 4, there are formed concave portions 41 corresponding to the land 32 and convex portions 42 corresponding to the grooves 31 having a thickness greater than the thickness of the concave portion 41. Each of the convex portions 42 serves as a recording track in which information is recorded, and is formed so as to convex with respect to the incident light beam B, that is, to convex toward the protective layer 2. Each of the concave portions 41 becomes a gap between adjacent recording tracks.

An adhesive 11 is coated on the first recording layer 4, and the second sheet-shaped base member 53 is provided on the adhesive. A translucent film (not shown) may be formed between the first recording layer 4 and the second sheet-shaped base member 53 as needed. As is the case with the first sheet 3, a fine embossed pattern composed of grooves 51 and lands 52 between two adjacent grooves 51 is formed on the second sheet-shaped base member 53. A second recording layer 6 composed of an organic material as with the first recording layer 4 is formed on the surface of the second sheet-shaped base member 53 so as to fill the grooves 51 of the second sheet-shaped base member 53 and to spread over the entire surface of the base member. In the second recording layer 6, as is the case with the first recording layer 4, there are formed concave portions 61 and convex portions 62 each having a greater thickness than the concave portion 61. Each of the convex portions 62 serves as a recording track and convexes with respect to the incident light beam B, that is, to convex toward the protective layer 2. The concave portions 61 each become a gap between adjacent recording tracks.

A reflecting layer 12 is formed by sputtering or the like on the second recording layer 6. The support substrate 7 for supporting the first sheet 3 and the second sheet 5 is stacked on the layer 12 with an adhesive 13 therebetween. The support substrate 7 is flat and has formed thereon no fine embossed pattern including a guiding groove for obtaining a tracking servo signal or the like.

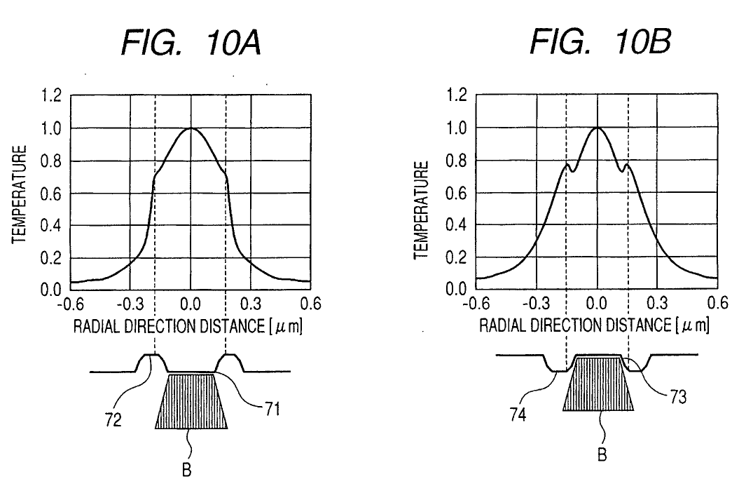

An optical recording medium with the constitution as described above provides a temperature distribution such as shown in FIG. 10A because the light beam B is incident on a recording track which is a convex with respect to the light beam B. A range in which the temperature is raised greatly is limited to the convex portions 42, 62, and the temperature rise in adjacent tracks is slight, so that an effect of expanding a recording power margin occurs. Since the recording/reproduction is performed with respect to the convex portions 42, 62 of a relatively large thickness, there is no need for applying an organic material in a thickness more than necessary, which is advantageous in terms of production cost and production efficiency.

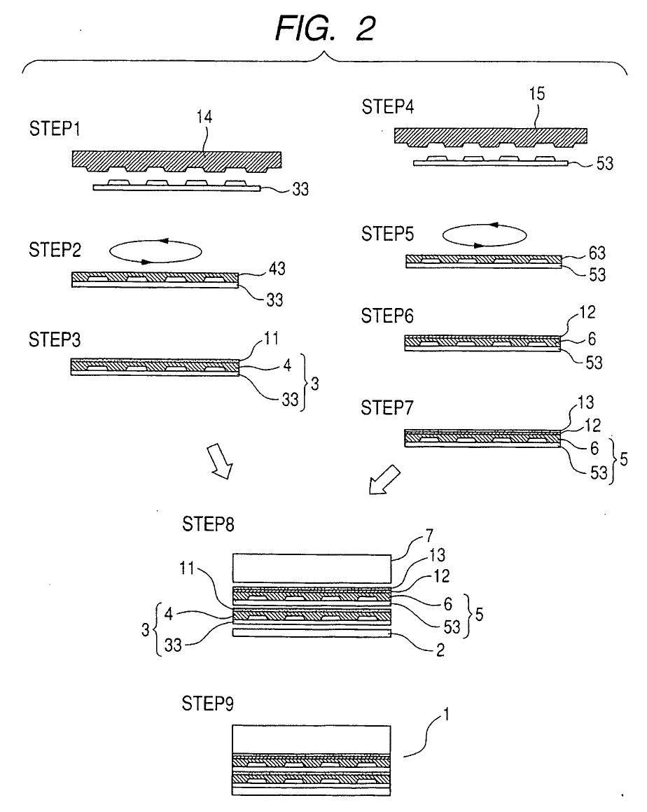

Next, a method of producing the optical recording medium described above will be described. FIG. 2 is a view schematically showing the production steps of the method of producing the optical recording medium.

First, as shown in Step 1, a fine embossed pattern such as lands and grooves is transferred from a stamper 14 having the fine embossed pattern formed thereon to a base member, whereby the first sheet-shaped base member 33 is formed. Next, as shown in Step 2, an organic material 43 is applied by spin coating to the first sheet-shaped base member 33 having the fine embossed pattern transferred thereon so as to fill the concave portions of the embossed pattern and to spread over the entire surface of the pattern, thus forming the first recording layer 4. A translucent film (not shown) may be provided on the organic material 43 as needed. Next, as shown in Step 3, the adhesive 11 is applied to the first recording layer 4, whereby the first sheet 3 in which the first recording layer 4 is formed is completed.

Next, as shown in Step 4, a fine embossed pattern such as lands and grooves is transferred from a stamper 15 having the fine embossed pattern formed thereon to a base member, whereby the second sheet-shaped base member 53 is formed. Next, as shown in Step 5, an organic material 63 is applied by spin coating to the second sheet-shaped base member 53 onto which the fine embossed pattern has been transferred. Thus, the second recording layer 6 is produced. Next, as shown in Step 6, the reflecting layer 12 is formed by sputtering or the like on the second recording layer 6. Next, as shown in Step 7, the adhesive 13 is applied to the reflecting layer 12, whereby the second sheet 5 in which the second recording layer 6 is formed is completed.

Here, Steps 1 to 3 of producing the first sheet 3, and Steps 4 to 7 of producing the second sheet 5 are independent of each other. Therefore, Steps 1 to 3 may be performed prior to Steps 4 to 7, or Steps 4 to 7 may be performed prior to Steps 1 to 3. Alternatively, Steps 1 to 3, and Steps 4 to 7 may be simultaneously performed.

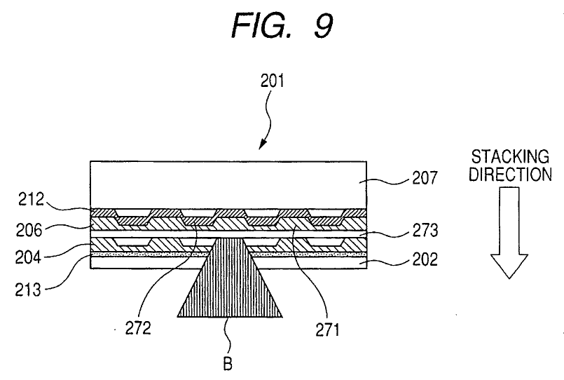

Next, as shown in Step 8, the two sheets 3, 5 onto which the fine embossed pattern is transferred respectively and in which the first or second recording layers 4, 6 are formed respectively are aligned with the support substrate 7, and are stacked and bonded to each other. Unlike the case of the second prior art shown in FIG. 9, the recording layers 4, 6 formed on the sheet-shaped base members 33, 53 are aligned with and bonded to each other in such a manner that the recording layers 4, 6 each form a surfaces close to the support substrate 7 (so as to face the support substrate 7). Furthermore, the protective layer 2 is formed in contact with the sheet-shaped base member most distant from the support substrate 7 (the sheet-shaped base member 33 in this case) . The protective layer 2 may be bonded by applying an adhesive as needed, or may be a sheet with an adhesive. Alternatively, the protective layer 2 may be formed by applying a resin or the like in a thickness smaller than that of the support substrate.

Next, as shown in Step 9, the adhesive is cured, and the stacked sheets 3, 5 are each processed into a predetermined shape, whereby the optical recording medium 1 is completed. Incidentally, when the protective layer 2 is formed through coating process, the process may be performed in this step.

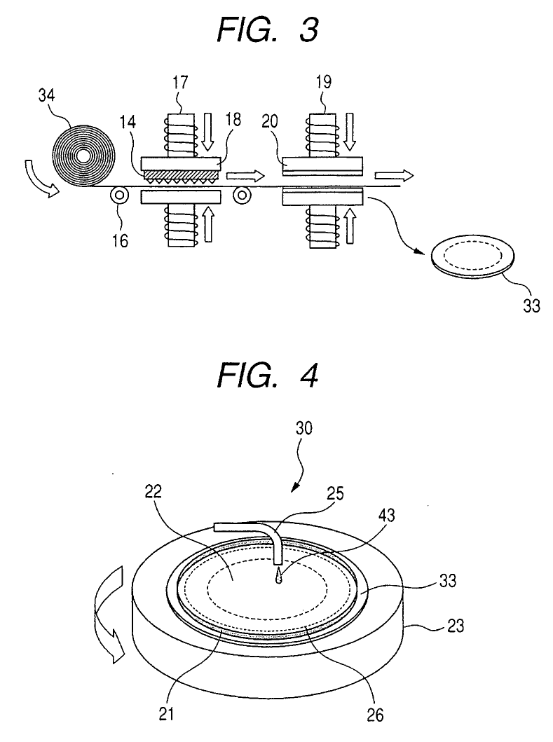

Next, the above-described method of producing the optical recording medium will be described in more detail with reference to FIGS. 3 to 6.

First, the steps of forming a sheet-shaped base member by transferring a guiding groove or the like from a stamper in Step 1 or 4 of FIG. 2 will be described (Description will be given by taking Step 1 as an example, but the same will apply to Step 4.). FIG. 3 is a schematic view showing production steps of a sheet-shaped base member.

First, a base member 34 processed into a sheet shape is prepared. As described below, any one of various methods can be used for forming a guiding groove or the like on the base member 34. First, when the base member 34 is composed of a thermoplastic resin, there can be adopted a method involving overlaying the base member 34 on the stamper 14, and subjecting the thermoplastic resin to either or both of pressurization and heating. After that, the thermoplastic resin is cooled as required, and the stamper 14 is peeled, whereby a guiding groove or the like is directly formed on the base member 34. Alternatively, there may be adopted another method involving forming a film (not shown) of a UV curable resin, a thermosetting resin, or a dry photopolymer on the base member 34 or the stamper 14, overlaying the remaining stamper 14 or base member 34 on the UV curable resin, and curing the resin layer with an energy ray such as ultraviolet light or through heating. After that, the stamper 14 is peeled, whereby a signal pattern formed layer is formed on the base member 34. Furthermore, the first sheet-shaped base member 33 having a guiding groove or the like may be formed by applying or overlaying an uncured or semi-cured, liquid or sheet-shaped resin to or on the stamper 14, and curing the resin with ultraviolet light, through heating, or by using any other means. As the resin, a UV curable resin, a thermosetting resin, or a dry photopolymer can be used. A protective sheet that can be peeled in a subsequent step may be formed on at least one surface of the resin. The formation of the protective sheet enables pressurization through the resin and the protective sheet on the stamper, so that the first sheet-shaped base member 33 can be easily obtained having a uniform thickness, and the conveyance and handling of the base member 34 are also facilitated. In the present invention, it is only necessary to form a predetermined guiding groove or the like on the base member 34, and the method of forming a guiding groove or the like is not limited to the above-mentioned method.

In addition, a peelable protective sheet may be formed on at least one surface of the base member 34 in the respective steps as needed and the protective sheet may be peeled in any steps. Thus, the base member 34 is protected, and a problem in terms of handling in, for example, steps of conveying or positioning the base member 34 can be easily dissolved. The thickness of the protective sheet can be arbitrarily selected. Upon peeling of the protective sheet, static electricity is apt to generate, so that a defect due to an adhesion of dust is apt to occur. Therefore, it is preferable that the protective sheet is subjected to an antistatic treatment, or the peeling work is performed in a decharging environment.

When the distance between layers is small, because the thickness of the base member 34 needs to be reduced, it is preferable that no resin layer is formed on the base member 34.

The materials for the base member 34 and a resin layer for forming a guiding groove or the like are not particularly limited as long as the materials cause no optical troubles upon recording, reproduction, and erasing. However, since the wavelength of light to be used is as short as 785 nm in a CD and 660 nm in a DVD, and since such a short wavelength as 405 nm may be used in the present invention, a material showing little absorption or reflection, and little birefringence in such a wavelength region is desirable. Specific examples of materials suitable for a sheet-shaped base member and a thermoplastic sheet base member each serving as a base for forming a signal pattern formed layer include, but not limited to, a polycarbonate resin, a polyolefin resin, and an acrylic resin. Examples of materials of a UV curable resin, a thermosetting resin, and a dry photopolymer include an acrylic material, an epoxy material, a urethane material, a phenol material, and various denatured materials. However, it is preferable to use a material showing little absorption in the above wavelength region, and especially to use a material in which the absorption wavelength region of a photopolymerization initiator is different from the wavelength region of light used for recording, reproduction, or erasing.

The base member 34 may have an arbitrary thickness, and the thickness thereof is preferably about 1 μm to 300 μm. An optimum thickness can be selected depending on, for example, the number of recording layers to be constituted and the dynamic range of a spherical aberration compensating mechanism. In addition, the thickness of each sheet of sheet-shaped base members to be stacked and adhesive layers can be made different for each layer. Optimizing the thickness of each sheet makes it possible to form an arbitrary interlayer distance with high accuracy.

The base member 34 to be used is preferably wound into a roll shape from the viewpoint of productivity. However, the base member is not necessarily wound into a roll shape, and may be of a sheet shape cut into a size necessary for each sheet. At that time, the shape is arbitrary, and may be quadrangular or circular. An opening as a central hole may either be provided or not provided. However, it is preferable that the base member is formed into a shape which secures a region in which the sheet can be appropriately held during positioning or conveyance.

Hereinafter, description will be made by taking a case where a thermoplastic resin is used for the base member 34 as an example. The base member 34 is conveyed by a conveying means such as a conveying roller 16 to a shaping device 17. In FIG. 3, a roller is used as the conveying means. However, as long as a required accuracy of conveyance is satisfied, the conveying means may be a belt conveyor system, an industrial robot, or the like and is not particularly limited. On the conveyed base member 34, a guiding groove or the like is transferred by the stamper 14 attached to a metal mold 18 of the shaping device 17. Subsequently, the base member 34 onto which the guiding groove is transferred is conveyed to a punching device 19, and is punched into a circular shape by a metal mold 20 for forming an external shape. Through the above-mentioned steps, the first sheet-shaped base member 33 onto which the guiding groove is transferred is completed.

The shaping device 17 may be of a press type for transferring a stamper shape through either or both of heating and pressurization. Cooling may performed after the transferring step as needed, whereby the sheet base member can be peeled off from the stamper. The shaping conditions such as a temperature, a pressure, a moving distance, and a cooling time are not particularly limited, and the optimum production conditions may be suitably selected depending on a guiding groove, a transfer material, a sheet thickness, or the like.

Next, the step of applying a recording layer to each of the first and second sheet-shaped base members will be described with reference to FIG. 4. This corresponds to Step 2 or 5 (Description will be made by taking Step 2 as an example, but the same will apply to Step 5.). FIG. 4 is a schematic view showing a method of applying a recording layer by spin coating. The first sheet-shaped base member 33 onto which the guiding groove or the like is transferred is subsequently conveyed to a recording layer coating device 30. In the recording layer coating device 30, an organic material 43 to serve as the first recording layer 4 is applied by spin coating to the guiding groove formed surface. As the organic material 43, an organic pigment-based material such as a cyanine-based material, a phthalocyanine-based material, or an azo-based material can be used. The thickness of the first recording layer 4 can be arbitrarily set. However, because the light will attenuate in each of recording and reflecting layers starting from the light incidence plane, it is preferable that a layer closer to the light incidence plane has a higher transmittance at the wavelength of the light used. That is, it is preferred that the transmittance of the first recording layer 4 is made higher than that of the second recording layer 6. In addition, at the same time, it is preferable that the composition and thickness of each of the recording and reflecting layers is adjusted so as not to cause any trouble during recording, reproduction, and erasing. By optimizing the composition, thickness, film forming conditions or the like for each of the sheet-shaped base members and the support substrates, a recording layer having an arbitrary transmittance and an arbitrary reflectance can be formed. In the present invention, as long as a recording layer material suitable for a required optical recording medium is used, the composition, thickness, and film forming conditions are not particularly limited.

The first sheet-shaped base member 33 is attached to a sheet fixing jig 21, and is then attached to the spin coater rotating portion 23 through, for example, adsorption fixing. The organic material 43 is dropped from the organic material supplying nozzle 25 onto an effective portion 22 of the first sheet-shaped base member 33. An organic material reservoir 26 capable of trapping an excessive portion of the organic material 43 as required is arranged outside the effective portion 22 of the first sheet-shaped base member 33. The organic material reservoir 26 can be easily formed by designing the shape of the sheet fixing jig 21.

The reflecting layer 12 may be formed on the second sheet 5 including the recording layer positioned distant from the light incidence plane. This corresponds to Step 6 of FIG. 2. As the material for the reflecting layer, there is used Al, an Al alloy, Si, SiN, Ag, an Ag alloy, or the like.

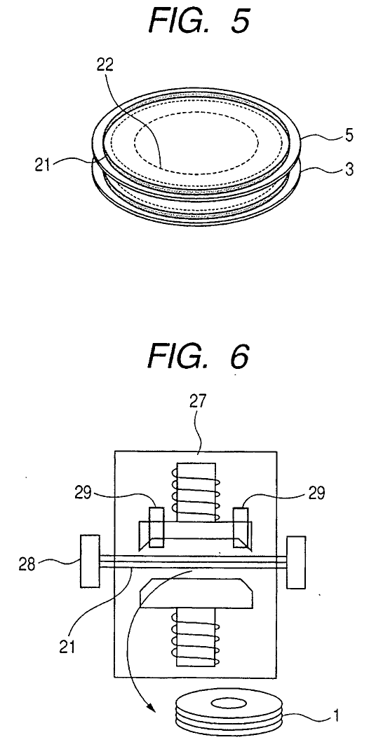

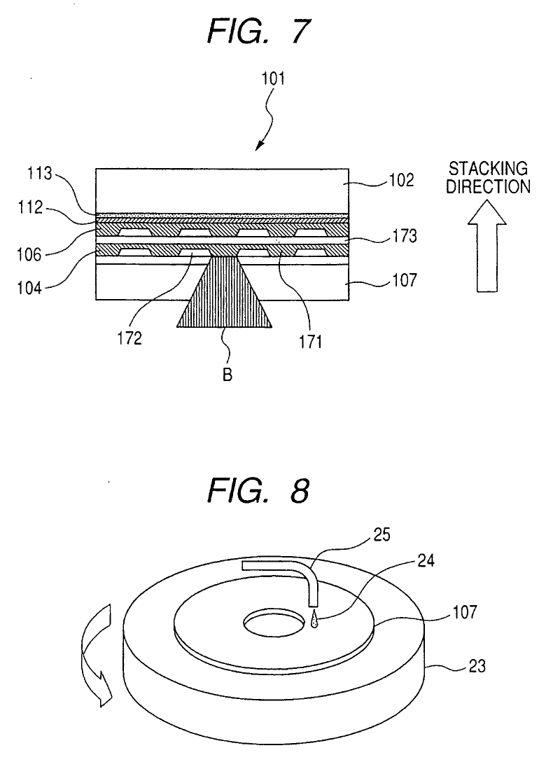

Subsequently, the step of stacking the respective sheets having the recording layer formed on the signal pattern will be described. FIG. 5 is a schematic view showing the step of stacking the sheets.

The respective sheets 3 and 5 in which recording layers corresponding to the number of recording layers to be produced are formed and which are attached to the sheet fixing jig 21 are overlaid on each other with the adhesive 11 therebetween. The adhesive may be applied through a spin coater as shown in FIG. 4, or may be dropped onto the effective portion 22 of the sheet before the sheets are overlaid on each other. It is necessary that upon overlaying the respective sheets, no air remains between the sheets to be stacked. In addition, the adhesive may be applied to both surfaces of the sheet, or may be applied to only one surface of the sheet. A sheet-shaped adhesive layer sandwiched between protective sheets may also be used. Alternatively, the step of applying an adhesive may be omitted by using a sheet-shaped base member having a sticking agent or adhesive applied to a surface thereof opposite to a transfer layer. Examples of the available adhesive include a cationic adhesive, a heat curable adhesive, a two-part adhesive, a UV adhesive, a hot melt, a pressure sensitive adhesive, and the like. However, as long as specifications required for an optical recording medium such as a light transmittance and a reflectance are satisfied, the adhesive is not particularly limited. The foregoing description holds true for the overlaying of the second sheet 5 and the support substrate 7. When the respective sheets and the support substrate are stacked, the respective layers may be temporarily fixed through an adhesive, or may be temporarily fixed through vacuum adsorption or by an electrostatic force without using an adhesive.

FIG. 6 is a schematic view showing a process step for forming the shape of an optical recording medium. First, a laminate of a plurality of sheets is collectively formed into the shape of the optical recording medium 1 by means of a shape forming device 27. When an adhesive is used for temporarily stacking the respective layers, the adhesive is then cured. The step of curing the adhesive can be performed prior to the shape forming process. In the step of overlaying the respective sheets, in order to prevent contamination of air or foreign matter, the respective sheets are desirably overlaid in a vacuum. Further, it is also preferable that a laminate of a plurality of sheets is sandwiched between flat plates from above and below in a vacuum or in the atmosphere and then horizontally pressurized, whereby the distances between the respective layers are made uniform and the adhesive layer is cured. Furthermore, it is more secure and preferable that the shape formation is performed in a state in which a plurality of sheets are horizontally pressurized from above and below in a vacuum or in the atmosphere. The shape formation can be performed by a punching press machine or any other methods such as laser processing or mechanical cutting, and the method for the shape formation is not particularly limited.

When performing the overlaying and shape formation of the sheet-shaped base members, a support substrate with a recording layer or reflecting layer may be inserted, or a support substrate having no recording layer or reflecting layer may be inserted. As the material of the support substrate, there are mainly used thermoplastic resins such as a polycarbonate resin, a polyolefin resin, or an acrylic resin, but there is no particularly limitation thereto. The support substrate may be overlaid on the sheet base members in advance before it is inserted, or may be overlaid after a laminate of sheets has been formed into an optical recording medium shape.

The recording medium processed into the shape of an optical recording medium is taken out from the shape forming device 27 with a handling means such as an arm (not shown). The shape forming steps performed by the shape forming device 27 needs to have a step of center position alignment of the respective recording layers (hereinafter, referred to as “centering”). The alignment in a direction perpendicular to a sheet conveying direction and in the sheet conveying direction is precisely performed by a driving device for alignment built in a guide portion 28 through the sheet fixing jig 21.

In this embodiment, the centering is performed by the stacking which provides some degree of adhesiveness and by providing the guide portion 28 with a rough positional adjustment mechanism, but the method of alignment is not particularly limited.

Positional information for the centering can be obtained by providing an alignment mark (not shown) outside of an information recording part of each sheet and detecting the alignment mark by a sensor 29 provided on a side of a punching portion. The alignment mark is provided outside of an effective region of the stamper 14, and can be transferred simultaneously with the transfer of a signal pattern form onto a sheet-shaped base member by the shape forming device 17. However, it is to be noted that a state in which the mark cannot be detected should not be established by film formation. Therefore, it is preferable that an area in which film formation is performed is larger than the effective region and does not reach the outer periphery of the optical recording medium shape, and further that an alignment mark is formed outside of the area. Depending on the reading system, the reflectance may be improved by film formation, so that the accuracy of detection of the mark may be increased. Therefore, an alignment mark can be provided in an arbitrary region.

### EXAMPLES Hereinafter, an example of the present invention will be described with reference to FIGS. 1 to 6.

First, in order to transfer a fine embossed pattern onto a base member 34, a stamper 14 made of nickel (Ni) was prepared. The stamper 14 can be easily produced by a widely used conventional method. In the method of producing an optical recording medium according to the present invention, it is possible to use the stamper 14 made of nickel that can be repeatedly used many times, so that there is no need of using a transparent stamper made of a resin which is to be disposed of after each use for shaping.

Next, a sheet-shaped base member 34 was prepared which was made of a polycarbonate resin and on one surface of which embossed patterns could be transferred. The base member 34 had a thickness of 25 μm, and a protective sheet having a thickness of 100 μm was formed on one surface of the base member 34 to provide the base member with a thickness such that the base member could be easily held and fixed. The base member 34 was wound in a roll shape before it was supplied.

The base member 34 was conveyed by a conveying roller 16 serving also as a guide mechanism to a press type shape forming device 17, and the conveyed base member 34 was heated/pressurized by a metal mold 18 having the stamper 14 attached thereto, whereby a fine embossed pattern shape was transferred. At this time, three alignment marks (not shown) to be used in a subsequent stacking step were transferred onto a region outside of the outer periphery of a substrate to be finally formed.

Next, the metal mold 18 was cooled so that the temperature of the base member 34 became lower than both the glass transition point and the heat deformation temperature thereof, and then the metal mold was opened and the base member 34 and the stamper 14 were peeled off from each other. The glass transition point and heat deformation temperature of the polycarbonate resin are 140° C. and about 120° C., respectively, and the temperature of the base member when opening the metal mold was about 30° C. to 40° C.

Next, the base member 34 onto which the fine embossed pattern shape had been transferred was conveyed to the punching device 19. The base member 34 was punched into a circular shape by a metal mold 20 attached to the punching device 19 for forming an external shape. At this time, the base member 34 was processed to have a circular shape with a diameter of 140 mm so as to leave outside the effective diameter region a margin to be attached to a sheet fixing jig in subsequent steps. Thus, a first sheet-shaped base member 33 onto which a guiding groove had been transferred was completed. A second sheet-shaped base member 53 was similarly produced.

Next, the first sheet-shaped base member 33 was attached to a sheet fixing jig 21, and an organic material 43 was applied onto the fine embossed pattern of the first sheet-shaped base member 33 in a thickness of 25 nm in a spin coating device, thus forming a first recording layer 4. In addition, the second sheet-shaped base member 53 was similarly attached to a sheet fixing jig 21, and an organic material was applied onto the fine embossed pattern of the second sheet-shaped base member 53 in a thickness of 25 nm in the spin coating device to form a second recording layer 6. After that, a reflecting layer 12 made of an Ag alloy was formed by a film forming device. Incidentally, in the optical recording medium having a multilayer constitution finally formed, the reflectance of the first recording layer 4 on the first sheet-shaped base member 33 was smaller than that of the second recording layer 6 on the second sheet-shaped base member 53. The reflectance was optimized not by varying the application conditions to change the thickness but by adding a reflecting layer 12.

Next, adhesives 11, 13 for lamination were applied to the first sheet 3 and the second sheet 5, respectively. A cationic adhesive was used for each of the adhesives 11, 13, and each adhesive was applied to the embossed-pattern-formed side of the sheet. After an appropriate amount of each of the adhesives 11, 13 had been dropped onto the sheet, the sheets were overlaid and pressed together with the sheet fixing jig 21 as shown in FIG. 5, and the film thickness was controlled by the pressure. The film thickness was 3 μm.

Next, the two sheets 3, 5 were mounted on a shape forming device 27 together with the sheet fixing jig 21, and the sheets were stacked in a state in which they were in contact with each other to some extent while the sheet fixing jigs 21 were held by a guide portion 28. After that, a support substrate 7 made of polycarbonate and having a thickness of 1.1 mm, an outer diameter of 120 mm, and an inner diameter of 15 mm was inserted into the lowermost portion of the sheets mounted on the shape forming device 27. At this time, a vacuum state was established inside the shape forming device 27 in such a manner that neither air nor foreign matter would remain between the sheets to be stacked in the guide portion 28. The shape of the support substrate 7 is not limited to a disk shape, and may be a sheet shape.

In the punching step performed by the shape forming device 27, at the time of the centering, an alignment mark (not shown) was detected by a sensor 29 provided on a side of a punching portion. In this example, the center positions of the patterns were aligned by the three alignment marks. The sheets were precisely aligned by a driving device for positional adjustment built in the guide portion 28.

After the stacking, the first sheet 3 and the second sheet 5 were collectively punched to have the same inner and outer diameters as those of the support substrate 7 and formed into a shape of an optical recording medium by the shape forming device 27, and then the adhesives were cured. After that, the optical recording medium was taken out from the shape forming device 27 with a handling means such as an arm (not shown).

After the resultant optical recording medium having a two-layer constitution had been taken out, a UV curable resin (INC-118 (trade name); manufactured by NIPPON KAYAKU CO., LTD.) was applied onto the stack surface by ordinary spin coating. After that, the applied resin was entirely cured by a UV curing device. As a result, a protective layer 2 having a thickness of 50 pm and an entirely uniform surface was formed, whereby the optical recording medium 1 having a two-layer constitution was completed.

Instead of the application of a resin as the protective layer 2, a sheet-shaped base member having no signal pattern is overlaid on the first sheet by using an adhesive upon overlaying of the respective sheets, and the base member and the respective sheets are collectively processed into a disk shape. Alternatively, the thickness of the first sheet-shaped base member 33 on which the first recording layer 4 is formed may be set to 75 μm, and the first sheet-shaped base member and a protective coat layer may be collectively produced. Since this technique eliminates the need for a step of forming a protective layer by spin coating or the like, and since it is only necessary to stack a base member which serves also as the protective layer 2, the productivity can be improved.

A light beam was allowed to be incident on the completed optical recording medium having the two-layer constitution from the protective layer 2 side to perform recording/reproduce of information. The recording/reproduction could be performed in each layer without any trouble, and a recording power margin of ±30% or more could be secured. Further, recording/reproduction could be performed also in an environment of a low temperature of 50° C. and in an environment of a high temperature of 45° C. On the other hand, an optical recording medium having a two-layer constitution produced by using the same organic material according to a prior art was able to secure a recording power margin of only ±10%, and failed to perform recording/reproduction in an environment of a high temperature of 45° C.

As described above, according to the optical recording medium and the method of producing the same of the present invention, the system in which a light beam is incident from a protective layer side can be adopted, and the thickness of a light transmissive substrate can be easily reduced. Consequently, the numerical aperture (NA) of an objective lens of a pickup can be increased to result in an increase in recording density.

In addition, since convex portions of a recording layer are used as recording tracks, portions having a large thickness of the recording layer can be effectively utilized, and the amount of the recording layer to be applied can be reduced.

Furthermore, since the convex portions are formed to convex toward the protective layer, a thermal influence of a light beam incident on a convex portion is hardly exerted on concave portions adjacent to the convex portion and further to convex portions adjacent to the concave portions, and a problem such as a cross-write hardly occurs.

Moreover, the method of producing an optical recording medium of the present invention enables the efficient production of such an optical recording medium. As a result, according to the present invention, there can be provided an optical recording medium that strikes a balance between a high track density and excellent mass productivity.

In addition, the expansion of a recording power margin can strike a balance between a high track density and excellent mass productivity.

This application claims priority from Japanese Patent Application No. 2005-172326 filed on Jun. 13, 2005, which is hereby incorporated by reference herein.

What is claimed is:

1. An optical recording medium, comprising:
a support substrate;
a protective layer with a thickness smaller than that of the support substrate provided on a light beam incidence side; and
a recording layer formed between the support substrate and the protective layer,
wherein the recording layer comprises a concave portion as a gap between recording tracks and a convex portion as a recording track having a thickness greater than that of the concave portion and formed so as to convex toward the protective layer.

2. The optical recording medium according to claim 1, wherein the recording layer is formed in plurality.

3. The optical recording medium according to claim 1, wherein the recording layer comprises an organic material.

4. The optical recording medium according to claim 1, wherein the protective layer has a thickness of more than 0 mm but no more than 0.3 mm.

5. A method of producing an optical recording medium, comprising the steps of:
forming an embossed pattern on a sheet-shaped base member;
forming a recording layer on the embossed pattern of the sheet-shaped base member; and
bonding the sheet-shaped base member and a support substrate such that a surface of the sheet-shaped base member having the recording layer formed thereon and a support surface of the support substrate face each other.

6. The method of producing an optical recording medium according to claim 5, wherein, in the bonding step, the sheet-shaped base member having the embossed pattern and the recording layer formed thereon is prepared in plurality, and the plurality of the sheet-shaped base members are aligned with each other and stacked and bonded to each other.

7. The method of producing an optical recording medium according to claim 5, wherein in the recording layer forming step, the recording layer is formed by spin coating.

8. The method of producing an optical recording medium according to claim 5, further comprising, after the bonding step, the step of forming a protective layer on the sheet-shaped base member.
